(19) United States
(12) Patent Application Publication
(10) Pub. No.: US 2011/0131364 A1
(43) Pub. Date: Jun. 2, 2011

(54) REPROGRAMMING A NON-VOLATILE SOLID STATE MEMORY SYSTEM

(75) Inventor: David George Gordon, Basingstoke (GB)

(73) Assignee: MATSUSHITA ELECTRIC INDUSTRIAL CO., LTD.

(21) Appl. No.: 10/593,469

(22) PCT Filed: Mar. 2, 2005
(86) PCT No.: PCT/GB2005/000788

§ 371 Date: Sep. 29, 2008

(30) Foreign Application Priority Data
Mar. 19, 2004 (GB) 0406237.8

(51) Int. Cl. G06F 12/02

(52) U.S. Cl. 711/103; 711/E12.008

(57) ABSTRACT

A non-volatile memory system (10) is provided. The system comprises: non-volatile memory (11) divided into a plurality of segments (11) each segment having an address in an address space, means for copying any one segment to be reprogrammed into a first RAM (RAM1), the first RAM having a size at least equal to the segment size. The system further comprises a second RAM (RAM2) for holding a reprogrammed code, writing means for writing the reprogrammed code from the second RAM into the at least one segment to be reprogrammed, and control means (MMU) arranged to enable execution of the programme from the first RAM during the reprogramming.

The present invention relates to the reprogramming of a part of a memory system that uses non-volatile memory and, particularly, to reprogramming a segmented memory system with in an embedded process system, for example flash memory.

In the past non-volatile flash memory has been treated as contiguous and, possibly continuous, storage area. Larger systems are known that comprise several flash memory chips which may not be adjoining in the memory space. When a change is required, therefore, the entire memory has to be reprogrammed. This is undesirable for a number of reasons. Firstly, as the amount of data to be transferred to an electronic device increases so the time taken for the reprogramming also increases. During this, increasing lengthy, reprogramming process the electric device is not in a usable state.

One approach that has been used to attempt to overcome these problems is to segment the memory. U.S. Pat. No. 6,295,603 discloses a system incorporating a segmented controlled system. This invention seeks to overcome the problem of overwriting program code vital to the system boot-up process. The segmentation of the memory, along with the provisions of segment pointers, results in the memory area containing the program to be executed not being mapped onto a specific location within the memory. Manipulation of the address pointers is then used to minimise the chance of an advertent over writing of the boot-up code.

It is evident from this document that the segmentation of a solid state memory is a powerful tool. However, the system disclosed in U.S. Pat. No. 6,295,603 makes only passive, rather than active use of segmentation to prevent unwanted overwriting of certain sections of a memory.

There are existing techniques that provide multiple “banks” of programme memory. The concept behind such systems is as follows: there are two banks of memory A and B. While bank A is executing the current version of the software, software A, bank B can be reprogrammed with new software, software B. When the reprogramming is complete, the system is instructed using a soft reset to use the new software. Although this does facilitate reverting to software A in the event of a problem with software B, there is a requirement for double the memory required for software A alone. Furthermore, the redirection of the system to read from the other memory bank requires a soft reset and this causes an interruption in service.

In other systems known in the art the new version of the program directly overwrites the old version. It is therefore not possible to regress to the earlier version of the program if, for some reason, the reprogramming is unsuccessful and the new version of the program fails to operate correctly. This is very unsatisfactory as it renders a functional, if out of date, system initially unusable.

The present invention has been developed to overcome these problems.

According to the present invention there is provided a non-volatile memory system comprising:

non-volatile memory divided into a polarity of segments each segment having an address in an address space,

means for copying any one segment to be reprogrammed into a first RAM, the first RAM having a size at least equal to the segment size,

a second RAM for holding a reprogrammed code,

writing means for writing the reprogrammed code from the second RAM into the segment, and

control means arranged to enable execution of the program from the first RAM during the reprogramming.

The use of two RAM areas is advantageous because it means that there is no need for spare program memory and therefore the memory segments may be used to full capacity. Furthermore, there is no need for a permanent re-write of address as the address reverts to the original address once the re-write has been completed.

The segments are preferably substantially equal in size. This minimises the size of RAM required as the RAM must be equal to the largest segment and if all of the segments are substantially the same size there will be no redundancy in the RAM.

Preferably each segment contains some unused space. This space is preferably a small proportion of the segment. This space allows for the reprogrammed version to be slightly larger than the original version of the code.

The area of RAM to be used in this technique is equal in size to a single memory segment. This facilitates a 1:1 transfer between any non-volatile memory segment and the RAM and then subsequent 1:1 transfer of the modified segment in the RAM back into the original memory segment.

Furthermore, according to the present invention there is provided a method of reprogramming a non-volatile solid state memory system comprising a plurality of segments each segment having an address in an address space, two RAMs each at least equal in size to a single memory segment, and control means capable of enabling the execution of the program from the first RAM during the reprogramming, the method comprising steps of:

copying at least one segment to be reprogrammed into the first RAM, diverting program execution to the first RAM,

holding a reprogrammed code in the second RAM,

writing the reprogrammed code from the second RAM into the at least one memory segment to be reprogrammed, and

reverting to the original address instructions for the segment.

The advantage of this method is that there is no requirement for spare memory segments and, furthermore, only a temporary divert of address is required.

Preferably there is so more provided a user interface for managing a method of reprogramming according to the present invention. The user interface is designed to guide the user through a reprogramming of a non-volatile solid state memory system comprising a plurality of memory segments each segment having an address in an address space, two RAMs each at least equal in size to a single memory segment, and control means capable of enabling the execution of the program from the first RAM during reprogramming, the user interface comprising:

a graphical representation of the embedded processor showing the contents of each segment, means for selecting the segment to be reprogrammed, and

means of implementing the method of reprogramming described above.

An example of the present invention will now be described with reference to the following figures in which:

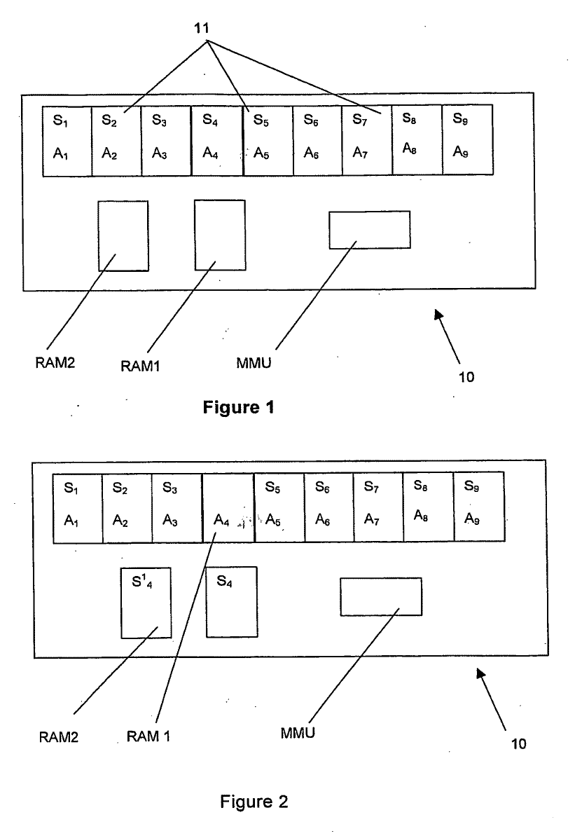

FIGS. 1, 2 and 3 show the effective parts of processor system according to the present invention undergoing reprogramming.

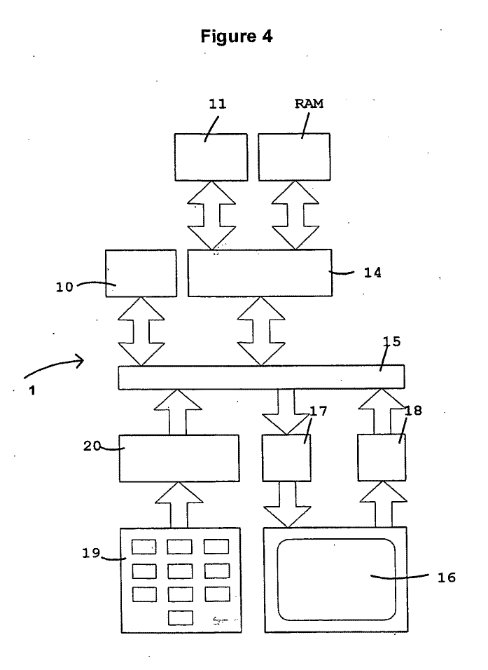

FIG. 4 is a schematic showing the connectivity of the embedded system of which the processor system of the present invention forms a part;

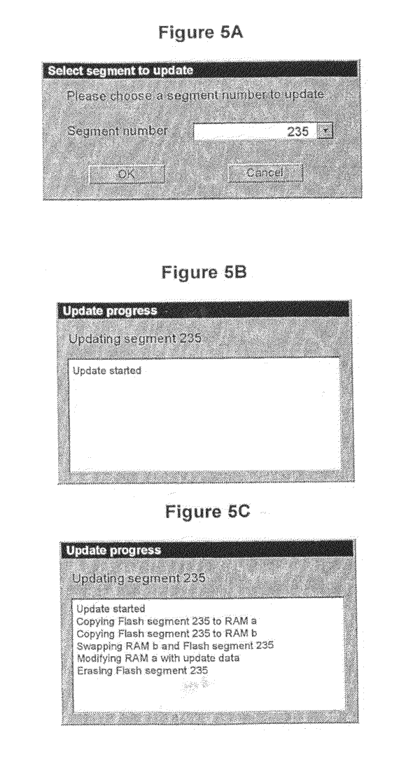

FIGS. 5a, b and c show the graphical user interface of the present invention during the reprogramming.

Each of FIGS. 1 to 3 shows the effective parts of a processing system 10 according to the present invention. The processing system 10 comprises a non-volatile memory 11 which, in this example, is divided into segments S₁ to S₉. It will be appreciated that the invention can be applied to a memory with other numbers of segments. Each of these segments S₁ to S₉ has a corresponding address in address space A1 to A9. The processor 10 also has two areas of RAM (RAM 1, RAM 2) that are the same size of one of the segments 11 and a memory management unit (MMU) or other logic to control the switching of segments within the address space.

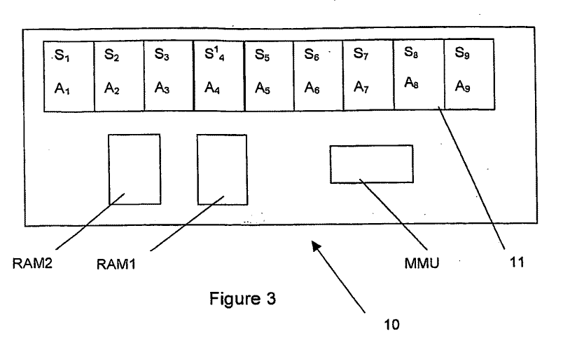

The process of reprogramming one segment, in this case segment S₄, is shown in FIGS. 1, 2 and 3. FIG. 1 represents the initial situation with each segment residing at an address having the same subscript as the segment number. Segment S₄ is to be modified. It is therefore copied into the RAM 1 and the memory management unit MMU instructs a divert to the version of S₄ stored in the RAM 1. This situation is shown in FIG. 2 where the RAM 1 contains the active version of S₄ which has temporarily been given the address A₄. The modified version of the program code intended for this segment is copied into and held in RAM 2 where the required modifications are made to the code. The modified program code from RAM 2 is then reprogrammed into memory segment S₄ and then the address divert is removed so that the processor executes the modified code now stored in segment S₄ as shown in FIG. 3.

FIG. 4 shows the processor system 10 within the context of a computer system 1. The volatile memory 11 and RAM communicate with the processor 10 via a system bus 15 and address control logic 14 that processes the change of address information required during the reprogramming. The graphical user interface appears on a display 16 to enable the user to instruct the reprogramming operation. This is convenient as the user must be able to control the process despite the fact that it is embedded deep within the computer system 1. Information from the processor 10 and address control logic 14 is supplied to the display 16 via the system bus 15 and display control logic 17. The user can use a mouse, touch screen or other suitable pointer to input commands which are subsequently fed back to the processor 10 via screen control logic 18. Alternatively the user can input commands through a keypad 19 that is connected, via keypad control logic 20, to the system bus 15.

FIGS. 5a, b and c show the graphical user interface at various stages during the reprogramming process. The first step is to download the package to the system. This will result in the window shown in FIG. 5a asking “Which Flash segment to update?” The user must then select a segment number “n” and proceed by either clicking the “OK” icon within the window, or giving a suitable command via the keyboard. The processor 10 then begins the reprogramming process and the user is informed of the progress of the reprogramming by a window that progresses from that shown in FIG. 5b to that shown in FIG. 5c as the process proceeds. This window is for information only as the user cannot interrupt the process once it has been initiated.

1. A non-volatile memory system comprising:
non-volatile memory divided into a polarity of segments each segment having an address in an address space,
means for copying any one segment to be reprogrammed into a first RAM, the first RAM having a size at least equal to the segment size,
a second RAM for holding a reprogrammed code,
writing means for writing the reprogrammed code from the second RAM into the at least one segment to be reprogrammed, and
control means arranged to enable execution of the programme from the first RAM during the reprogramming.

2. The system according to claim 1, wherein the segments are substantially equal in size.

3. The system according to claim 1 or claim 2, wherein each segment contains some unused space.

4. The system according to any of claims 1 to 3, wherein the control means comprises internal logic components.

5. A method of reprogramming a non-volatile solid state memory system comprising a priority of segments each segment having an address in an address space, two RAMs each at least equal in size to a single memory segment, and control means capable of enabling the execution of the program from the first RAM during reprogramming, the method comprising steps of:
copying at least one segment to be reprogrammed into the first RAM,
diverting programme execution to the first RAM,
holding a reprogrammed code in the second RAM,
writing the reprogrammed code from the second RAM into the at least one segment to be reprogrammed, and
reverting to the original address instructions for the segment.

6. A user interface for guiding a user through a reprogramming of a non-volatile solid state memory system comprising a polarity of segments each segment having an address in an address space, two RAMs each at least equal in size to a single memory segment, and control means capable of enabling the execution of the programme from the first RAM during the reprogramming, the user interface comprising:
a graphical representation of the imbedded processor showing the contents of each segment,
means for selecting the segment to be reprogrammed, and
means of initiating the method of reprogramming according to any one of claims 5 to 7.
